(19) United States
(12) Patent Application Publication
(10) Pub. No.: US 2025/0363589 A1
(43) Pub. Date: Nov. 27, 2025

(54) FRAME INTERPOLATION SYSTEM, OPERATING METHOD OF THE FRAME INTERPOLATION SYSTEM, AND IMAGE PROCESSING DEVICE INCLUDING THE SAME

(71) Applicant: Samsung Electronics Co., Ltd., Suwon-si (KR)

(72) Inventors: Yowon JEONG, Suwon-si (KR); Junsik Jung, Daejeon (KR); Sungeui Yoon, Daejeon (KR)

(73) Assignees: Samsung Electronics Co., Ltd., Suwon-si (KR); Korea Advanced Institute of Science And Technology, Daejeon (KR)

(21) Appl. No.: 19/027,643

(22) Filed: Jan. 17, 2025

(30) Foreign Application Priority Data
May 23, 2024 (KR) 10-2024-0067262

(51) Int. Cl. G06T 3/4007; G06T 3/4046; G06T 5/50; G06T 5/60

(52) U.S. Cl. CPC G06T 3/4007; G06T 3/4046; G06T 5/50; G06T 5/60; G06T 2207/20084; G06T 2207/20221

(57) ABSTRACT

Provided are a frame interpolation system, an operating method of a frame interpolation system, and an image processing device including the same. The frame interpolation system according to one or more embodiments may include a first plurality of encoders, a second plurality of encoders, a third encoder, a first feature fusion module, a second feature fusion module, a weight map generation module, a blending module, and a decoder.

### CROSS-REFERENCE TO RELATED APPLICATION

This application is based on and claims priority under 35 U.S.C. § 119 to Korean Patent Application No. 10-2024-0067262, filed on May 23, 2024, in the Korean Intellectual Property Office, the disclosure of which is incorporated by reference herein in its entirety.

### BACKGROUND

### 1. Field

The disclosure relates to an electronic device. Specifically, the disclosure relates to a frame interpolation system, an operating method of the frame interpolation system, and an image processing device including the frame interpolation system.

### 2. Description of Related Art

Recently, as the demand for high-quality and high-definition photos and videos has increased, image data generated from an image sensor may be efficiently processed using a neural network processor. Deep learning or machine learning for image processing may be implemented using neural networks.

Various types of neural network models based on machine learning or deep learning have been applied to artificial intelligence systems. With the development of neural network technology and the development and distribution of hardware that can play and store high-resolution and high-definition videos or high frame rate slow motion videos, the need for a method and a device for effectively generating interpolation frames of images by using neural networks is increasing.

### SUMMARY

The disclosure provides a frame interpolation system, an operating method of the frame interpolation system, and an image processing device capable of outputting high-quality images by receiving a plurality of pieces of frame data, a plurality of pieces of event data, and target event data by using a neural network.

According to one or more example embodiments, a frame interpolation system may include: a first plurality of encoders that receives first frame data and first event data to generate first feature data and first event feature data, a second plurality of encoders that receives second frame data and second event data to generate second feature data and second event feature data, a third encoder that receives target event data at a target time point to generate target event feature data, a feature fusion module that generates first fusion feature data based on the first feature data and the first event feature data and generates second fusion feature data based on the second feature data and the second event feature data, a weight map generation module that generates a first weight map and a second weight map by receiving the first event feature data, the second event feature data, the target event feature data, and the target time point, a blending module that generates output feature data by performing an operation on the first fusion feature data, the second fusion feature data, the first weight map, and the second weight map, and a decoder that generates output frame data by decoding the output feature data.

According to one or more example embodiments, an operating method of a frame interpolation system may include: receiving a plurality of pieces of frame data, a plurality of pieces of event data, and target event data, generating a plurality of pieces of feature data and a plurality of pieces of event feature data by encoding the plurality of pieces of frame data and the plurality of pieces of event data, generating target event feature data by encoding the target event data, generating a plurality of pieces of fusion feature data by fusing the plurality of pieces of feature data and the plurality of pieces of event feature data, generating a plurality of weight maps by receiving the plurality of pieces of event feature data, the target event feature data, and a target time point, generating output feature data by performing an operation on the plurality of weight maps and the plurality of pieces of fusion feature data, and generating output frame data by decoding the output feature data.

According to one or more example embodiments, an image processing device may include: a frame interpolation system that performs an image processing operation on input images to produce output images, wherein the frame interpolation system includes a first encoder that receives and encodes first frame data to generate first feature data, a second encoder that receives and encodes first event data to generate first event feature data, a third encoder that receives and encodes target event data to generate target event feature data, a fourth encoder that receives and encodes second frame data to generate second event feature data, a fifth encoder that receives and encodes second event data to generate second feature data, a first feature fusion module that generates first fusion feature data by receiving the first feature data and the first event feature data, a second feature fusion module that generates second fusion feature data by receiving the second feature data and the second event feature data,
a weight map generation module that generates a first weight map and a second weight map by receiving the first event feature data, the second event feature data, the target event feature data, and a target time point, a blending module that generates output feature data by performing an operation on the first fusion feature data, the second fusion feature data, the first weight map, and the second weight map, and a decoder that generates output frame data by decoding the output feature data, wherein the frame interpolation system includes a neural network.

According to one or more example embodiments, an image processing device may include: at least one processor; and memory storing instructions that, when executed by the at least one processor, cause the at least one processor to: obtain a first frame at a first time point and a second frame at a second time point from image data; identify a target event occurring between the first frame and the second frame at a target time point between the first time point and the second time point; determine that the target time point is closer to the first time point, or that the target time point is closer to the second time point; based on the target time point being closer to the first time point, generate an interpolated frame featuring the target event using deblurred data from the first frame; based on the target time point being closer to the second time point, generate the interpolated frame featuring the target event using deblurred data from the second frame; and output the interpolated frame.

### BRIEF DESCRIPTION OF THE DRAWINGS

Embodiments will be more clearly understood from the following detailed description taken in conjunction with the accompanying drawings in which:

FIG. 1 is a block diagram of an electronic device according to one or more embodiments;

FIG. 2 is a schematic block diagram of an image signal processor according to one or more embodiments;

FIG. 3 is a block diagram of a frame interpolation system according to one or

more embodiments;

FIG. 4 is a block diagram of a weight map generation module according to one or more embodiments;

FIG. 5 is a flowchart of an operating method of a frame interpolation system according to one or more embodiments;

FIG. 6 is a block diagram of a frame interpolation system according to one or more embodiments;

FIG. 7 is a block diagram of a frame interpolation system according to one or more embodiments;

FIG. 8 is a block diagram of an electronic device including a multi-camera module according to one or more embodiments;

FIG. 9 is a detailed block diagram of the camera module in FIG. 8; and

FIG. 10 is a block diagram of an electronic device according to one or more embodiments.

### DETAILED DESCRIPTION

Hereinafter, embodiments are described in detail with reference to the attached drawings.

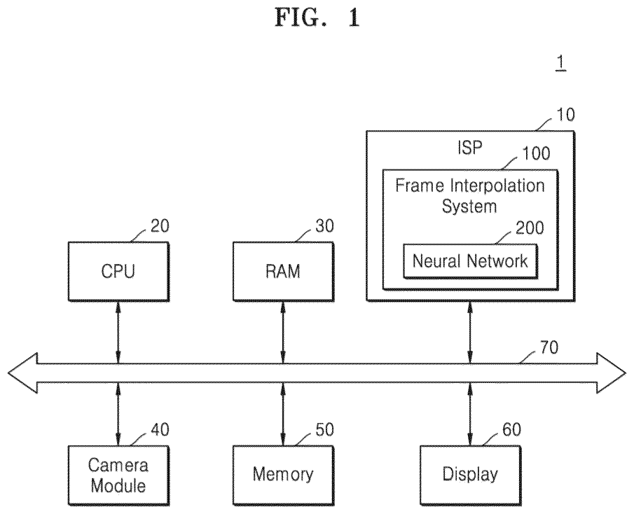

FIG. 1 is a block diagram of an electronic device 1 according to one or more embodiments.

Referring to FIG. 1, the electronic device 1 may include an image signal processor (ISP) 10, a central processing unit 20, random-access memory (RAM) 30, a camera module 40, memory 50, a display 60, and a system bus 70. According to one or more embodiments, the electronic device 1 may further include general-purpose components other than those shown in FIG. 1. For example, the electronic device 1 may further include an input/output module, a security module, a power control device, and the like and may also further include various types of processors. Additionally, according to one or more embodiments, at least one of the components in FIG. 1 may be omitted from the electronic device 1. The components of the electronic device 1 may communicate with each other through the system bus 70.

The electronic device 1 according to one or more embodiments may perform image processing operations on input images based on a neural network (NN) and generate output images. The electronic device 1 may include at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. In addition, the electronic device 1 may include a smart home appliance. The smart home appliance may include, e.g., at least one of a television, a digital video disk (DVD) player, an audio system, a refrigerator, an air conditioner, a vacuum cleaner, an oven, a microwave oven, a washing machine, an air purifier, a set-top box, a home automation control panel, a security control panel, a TV box, a game console, an electronic dictionary, an electronic key, a camcorder, or an electronic picture frame.

For example, the electronic device 1 may include an application processor. The application processor may process various types of operations. The electronic device 1 may further include a neural processing unit (NPU) that shares operations to be processed using the NN.

In some embodiments, some or all of the components of the electronic device 1 may be formed on one semiconductor chip. For example, the electronic device 1 may be implemented as a system on chip (SoC), and in some embodiments, may be referred to as an image chip.

The ISP 10 may refer to an image processing device. Hereinafter, in this specification, the ISP 10 may be also referred to as an image processing device. The ISP 10 may perform image processing on an input image to generate an output image. The ISP 10 may include a frame interpolation system 100, wherein the frame interpolation system 100 may include an NN 200. The electronic device 1 may generate (or infer) an interpolation frame based on a plurality of pieces of frame data input based on the NN 200 and may train the NN 200 based on the generated interpolation frame data and the plurality of pieces of frame data.

The interpolation frame data may include frame data generated based on at least two consecutive pieces of frame data and may be temporally located between the two pieces of frame data. By generating the interpolation frame data, the number of frames of existing video (continuous frames) or real-time rendering video may increase and image quality deterioration, such as video shaking, may be prevented so that the image is expressed naturally.

Since the interpolation frame data is not actually captured frame data but frame data generated based on actually captured frame data, the interpolation frame data may be different from ground truth (GT) frame data.

The goal of image frame interpolation is to generate accurate intermediate frame data (or interpolation frame data) between two pieces of input frame data. The performance of image frame data interpolation algorithms depends on high-level inference quality about motion and occlusion across two frames. To achieve a high level of inference quality, the frame interpolation system 100 may train the NN 200.

The ISP 10 may perform image processing on an input image by using the NN 200 and generate an output image. The input image may also be referred to as input image data, input data, etc. The frame interpolation system 100 may train (or learn) the NN 200 or analyze input data by using the NN 200 to infer information included in the input data.

The NN 200 may perform neural network operations based on received input images. Furthermore, the NN 200 may generate information signals based on the results of the neural network operations. The NN 200 may be implemented as a neural network operation accelerator, a co-processor, a digital signal processor (DSP), an application specific integrated circuit (ASIC), a field-programmable gate array (FPGA), a graphics processing unit (GPU), an NPU, a tensor processing unit (TPU), and a multi-processor system-on-chip (MPSoC).

The NN 200 may include an NN 200 based at least one of an artificial neural network (ANN), a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, a plain residual network, a dense network, a hierarchical pyramid network, and a fully convolutional network. However, the NN 200 is not limited to the above.

The ISP 10 may receive an input image. For example, the ISP 10 may receive the input image from the camera module 40. Specifically, the ISP 10 may receive the input image generated from an image sensor of the camera module 40 and perform image processing operations on the input image to generate an output image. However, the ISP 10 is not necessarily limited thereto. The ISP 10 may perform the image processing operations on the input image previously stored in the electronic device 1 or may perform the image processing operations on the input image received from the outside of the electronic device 1.

The ISP 10 according to one or more embodiments may receive the input image and event data from the camera module 40 or the memory 50 and perform neural network operations based thereon. The ISP 10 may perform the image processing operations defined through the neural network operations.

The NN 200 according to one or more embodiments may be trained to perform the image processing operations on the input image. The NN 200 may generate an output image by performing the image processing operations on the input image. In one or more embodiments, the image processing operations may include super-resolution operations that generate a high-resolution image of the input image. The input image may include an image having noise or a low-resolution image. The output image may include a higher resolution image than the input image and may include an image with improved quality than the input image.

According to one or more embodiments, the ISP 10 may further perform various image processing operations, such as a bad pixel correction (BPC) operation, an X-talk correction operation, a remosaic operation, a demosaic operation, and a denoise operation. However, the image processing operations are not limited to the above.

The frame interpolation system 100 according to one or more embodiments may receive a plurality of pieces of frame data, a plurality of pieces of event data, and target event data from the image sensor and an event sensor of the camera module 40. The plurality of pieces of frame data may include first frame data and second frame data and the plurality of pieces of event data may include first event data and second event data. For example, the first frame data and the first event data may include data generated during a first exposure section of the camera module 40 and the second frame data and the second event data may include data generated during a second exposure section of the camera module 40. The second exposure section may be continuous with the first exposure section and the time length of the first exposure section may be the same as or different from the time length of the second exposure section. The data generated during the first exposure section refers to one frame of image data or event data generated based on an amount of light received by the image sensor during the first exposure section. The data generated during the second exposure section refers to one frame of image data or event data generated based on an amount of light received by the image sensor during the second exposure section.

The frame interpolation system 100 may generate interpolation (intermediate) frame data based on the first frame data, the first event data, the second frame data, the second event data, and the target event data.

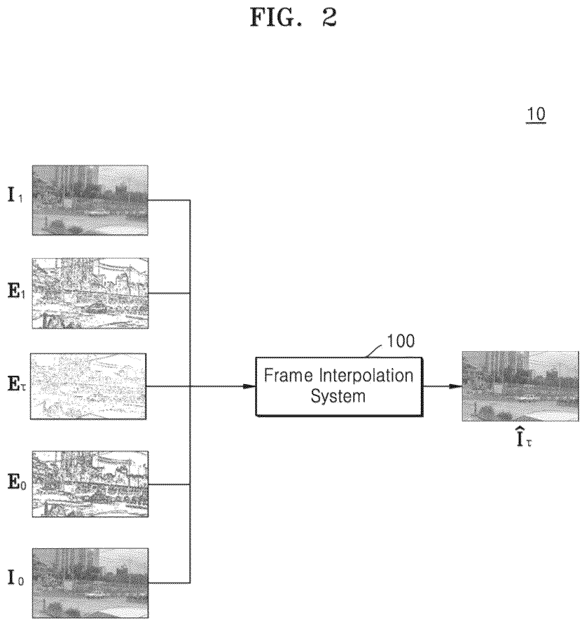

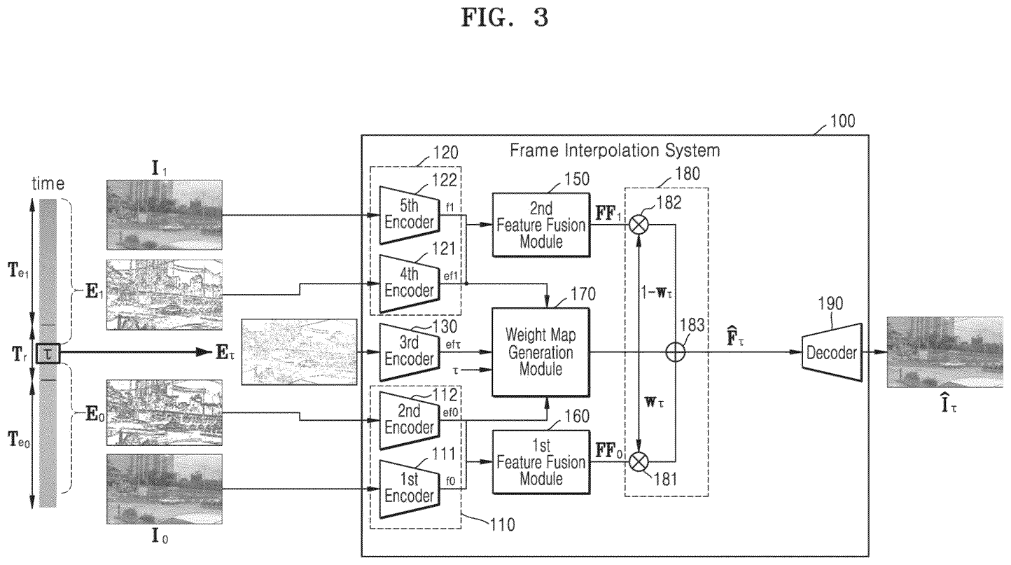

The frame interpolation system 100 may be described in detail with reference to FIGS. 2 and 3.

The frame interpolation system 100 may use the NN 200, which is trained to perform the image processing operations to generate high-quality and high-resolution images.

The camera module 40 may photograph a subject (or object) outside the electronic device 1 and generate frame data and event data. For example, the camera module 40 may include the image sensor and the event sensor.

The image sensor may convert an optical signal of a subject into an electrical signal by using an optical lens. To this end, the image sensor may include a pixel array in which a plurality of pixels are two-dimensionally arranged. For example, one color among a plurality of reference colors may be assigned to each of the plurality of pixels. For example, the plurality of reference colors may include red, green, and blue (RGB), or red, green, blue, and white (RGBW).

The event sensor may detect changes in the intensity of light from the optical lens. For example, the event sensor may detect an event in which the light intensity increases (hereinafter referred to as an on-event) and/or an event in which the light intensity decreases (hereinafter referred to as an off-event). The event sensor may generate signals upon detecting a change in the intensity of light that exceeds an event threshold. The event sensor may generate event frame data based on the generated signals. For example, the event sensor may include a dynamic vision sensor (DVS).

The camera module 40 may generate an input image by using the image sensor. The input image may be referred to variously as image data, image frame, and frame data. The input image may be provided as input data to the ISP 10 or may be stored in the memory 50. The input image stored in the memory 50 may be provided as input data to the ISP 10.

The CPU 20 controls the overall operation of the electronic device 1. The CPU 20 may include one processor core (single core) or may include a plurality of processor cores (multi-core). The CPU 20 may process or execute programs and/or data stored in a storage area, such as the memory 50, by using the RAM 30.

The memory 50 may include at least one of volatile memory or nonvolatile memory. The non-volatile memory includes read-only memory (ROM), programmable ROM (PROM), electrically programmable ROM (EPROM), an electrically erasable and programmable ROM (EEPROM), flash memory, phase-change RAM (PRAM), magnetic RAM (MRAM), resistive RAM (RRAM), and the like. The volatile memory includes dynamic RAM (DRAM), static RAM (SRAM), synchronous DRAM (SDRAM) and ferroelectric RAM (FeRAM). In one or more embodiments, the memory 50 may include at least one of a hard disk drive (HDD), a solid state drive (SSD), a compact flash (CF) card, a secure digital (SD) card, a micro-secure digital (Micro-SD) card, and a mini secure digital (Mini-SD) card, an extreme digital (xD) card, or a memory stick.

The display 60 may display various contents (e.g., text, images, videos, icons, or symbols) to a user based on image data received from the ISP 10. For example, the display 60 may include a liquid crystal display (LCD), a light emitting diode (LED) display, an organic light emitting diode (OLED) display, or a micro-electromechanical system (MEMS) display, or an electronic paper display. The display 60 may include a pixel array in which a plurality of pixels are arranged in a matrix form to display an image.

FIG. 2 is a schematic block diagram of the ISP 10 according to one or more embodiments.

Referring to FIG. 2, the ISP 10 may perform image processing operations on a plurality of pieces of frame data I₀ and I₁, a plurality of pieces of event data E₀ and E₁, and target event data E_{τ} through the frame interpolation system 100 to generate output frame data Î_{τ}.

The frame interpolation system 100 may receive first frame data I₀, first event data E₀, target event data E_{τ}, second frame data I₁, and second event data E₁. The frame interpolation system 100 may generate the output frame data Î_{τ} based on the received first frame data I₀, first event data E₀, target event data Er, second frame data I₁, and second event data E₁. The first event data E₀ may correspond to the first frame data I₀ and the second event data E₁ may correspond to the second frame data I₁. The target event data E_{τ} may correspond to a target time point.

According to one or more embodiments, the resolution of the first event data E₀ does not need to match the resolution of the first frame data I₀ and the resolution of the second event data E₁ does not need to match the resolution of the second frame data I₁.

The operating method of the frame interpolation system 100 and the configuration of the frame interpolation system 100 may be described with reference to FIG. 3.

FIG. 3 is a block diagram of the frame interpolation system 100 according to one or more embodiments.

Referring to FIG. 3, the frame interpolation system 100 may include a first encoder group 110, a second encoder group 120, a third encoder 130, a first feature fusion module 160, a second feature fusion module 150, a weight map generation module 170, a blending module 180, and a decoder 190. In one or more embodiments, first feature fusion module 160, second feature fusion module 150, weight map generation module 170, and/or blending module 180 are implemented as software. In alternative embodiment(s), first feature fusion module 160, second feature fusion module 150, weight map generation module 170, and/or blending module 180 are implemented as hardware.

The first encoder group 110, i.e., a first plurality of encoders, may include a first encoder 111 and a second encoder 112. During a first exposure section Tₑ₀, the first frame data I₀ and the first event data E₀ may be generated. The first frame data I₀ and the first event data E₀ may be generated from the camera module 40 in FIG. 1. For example, a section for accumulating the signals of the event sensor to generate the first event data E₀ is not necessarily limited to the first exposure section Tₑ₀ for generating the first frame data I₀ and may include a longer section, including the first exposure section Tₑ₀, than the first exposure section Tₑ₀.

The first encoder group 110 may encode the first frame data I₀ and the first event data E₀ to extract or generate first feature data f0 and first event feature data ef0. In one or more embodiments, the first encoder 111 may encode the first frame data I₀ to generate the first feature data f0 and the second encoder 112 may encode the first event data E₀ to generate the first event feature data ef0.

The third encoder 130 may encode the target event data E_{τ} to generate target event feature data eft. The target event data E_{τ} may be generated during all or part of a readout section Tᵣ between the first exposure section Tₑ₀ and the second exposure section Tₑ₁. A target time point τ may be in the readout section Tᵣ. For example, a section for generating the target event data E_{τ} may include a very short time interval before and after the target time point τ, with respect to the target time point τ.

The second encoder group 120, i.e., a second plurality of encoders, may include a fourth encoder 121 and a fifth encoder 122. During the second exposure section Tₑ₁, the second event data E₁ and the second frame data I₁ may be generated. The second frame data <<mth3>> and the second event data E₁ may be generated from the camera module 40 in FIG. 1. For example, a section for accumulating the signals of the event sensor to generate the second event data E₁ is not necessarily limited to the second exposure section Tₑ₁ for generating the second frame data I₁ and may include a longer section, including the second exposure section Tₑ₁, than the second exposure section Tₑ₁.

The second encoder group 120 may encode the second frame data I₁ and the second event data E₁ to extract or generate second feature data f1 and second event feature data ef1. In one or more embodiments, the fourth encoder 121 may encode the second event data E₁ to generate second event feature data ef1 and the fifth encoder 122 may encode the second frame data I₁ to generate second feature data f1.

In one or more embodiments, the first to fifth encoders 111, 112, 121, 122, and 130 may include a CNN model. The first encoder 111 and the fifth encoder 122 may share parameters necessary for performing an encoding operation and the second encoder 112 and the fourth encoder 121 may share parameters necessary for performing an encoding operation.

The first feature fusion module 160 may receive the first feature data f0 and the first event feature data ef0, each generated by the first encoder group 110. For example, the first feature fusion module 160 may receive the first feature data f0 generated by the first encoder 111 and the first event feature data ef0 generated by the second encoder 112. The first feature fusion module 160 may generate first fusion feature data FF0 based on the first feature data f0 and the first event feature data ef0. The first fusion feature data FF0 may include data that is a fusion of the first feature data f0 and the first event feature data ef0.

The second feature fusion module 150 may receive the second feature data f1 and the second event feature data ef1, each generated by the second encoder group 120. For example, the second feature fusion module 150 may receive the second event feature data ef1 generated by the fourth encoder 121 and the second feature data f1 generated by the fifth encoder 122. The second feature fusion module 150 may generate second fusion feature data FF1 based on the second feature data f1 and the second event feature data ef1. The second fusion feature data FF1 may include data that is a fusion of the second feature data f1 and the second event feature data ef1.

In one or more embodiments, the first feature fusion module 160 and the second feature fusion module 150 may include a CNN model. The first feature fusion module 160 and the second feature fusion module 150 may share parameters necessary for generating the first fusion feature data FF0 and the second fusion feature data FF1.

The weight map generation module 170 may receive the first event feature data ef0, the second event feature data ef1, the target event feature data eft, and the target time point τ. For example, the weight map generation module 170 may receive the first event feature data ef0 generated by the second encoder 112, the second event feature data ef1 generated by the fourth encoder 121, the target event feature data efτ generated by the third encoder 130, and the target time point t from the outside (e.g., CPU 20 in FIG. 1).

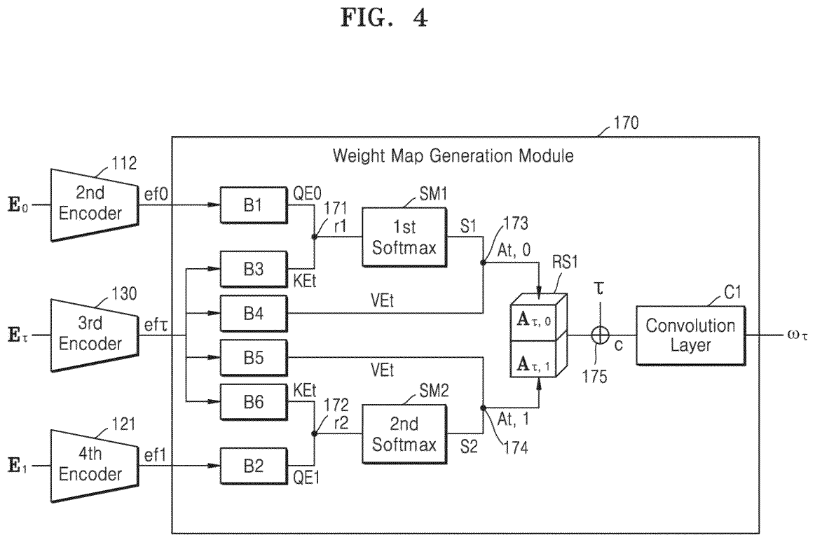

The weight map generation module 170 may generate a first weight map w_{τ} and a second weight map 1−w_{τ} for the target time point t by using the first event feature data ef0, the second event feature data ef1, the target event feature data eft, and the target time point τ. The method by which the weight map generation module 170 generates the first weight map w_{τ} and the second weight map 1−w_{τ} may be described with reference to FIG. 4.

The blending module 180 may include a first multiplier 181, a second multiplier 182, and an adder 183.

The first multiplier 181 may perform an element-wise multiplication operation of the first fusion feature data FF0 and the first weight map w_{τ}. For example, the first multiplier 181 may perform an element-wise multiplication operation of the first fusion feature data FF0 generated by the first feature fusion module 160 and the first weight map w_{τ} generated by the weight map generation module 170.

The second multiplier 182 may perform an element-wise multiplication operation of the second fusion feature data FF1 and the second weight map 1−w_{τ}. For example, the second multiplier 182 may perform an element-wise multiplication operation of the second fusion feature data FF1 generated by the second feature fusion module 150 and the second weight map 1−w_{τ} generated by the weight map generation module 170.

The adder 183 may add an output value of the first multiplier 181 to an output value of the second multiplier 182. The adder 183 may generate output feature data fz for the target time point t through an addition operation.

The blending module 180 may blend the generated output feature data fr. The blending may refer to performing an operation on the plurality of pieces of fusion feature data FF0 and FF1 and the plurality of weight maps w_{τ} and 1−w_{τ}, each input to the first multiplier 181, the second multiplier 182, and the adder 183 to generate the output feature data \hat{F}_{τ}.

The decoder 190 may decode the output feature data \hat{F}_{τ} to generate the output frame data Î_{τ} for the target time point τ. The output frame data Î_{τ} may include intermediate frame data or interpolation frame data between the first frame data I₀ and the second frame data I₁.

The intermediate frame data may include data generated based on the first frame data I₀ and the second frame data I₁ when the target time point t is in the readout section Tᵣ.

In one or more embodiments, the decoder 190 may include a CNN model.

According to a comparative example, since the frame interpolation system generates interpolation frame data by using only a plurality of pieces of frame data, it may be difficult to generate accurate interpolation frame data.

However, according to one or more embodiments, the frame interpolation system 100 may generate the accurate interpolation frame data Î_{τ} based on the first frame data I₀, the first event data E₀, the second frame data I₁, the second event data E₁, and the target event data E_{τ}. Accordingly, an image with high quality and high refresh rate may be generated during the image processing operation.

In addition, according to one or more embodiments, the frame interpolation system 100 may receive a plurality of pieces of frame data generated from the image sensor of the camera module (40 in FIG. 1) and may receive a plurality of pieces of event data and target event data generated from the event sensor thereof. The frame interpolation system 100 may generate the image with high quality and high refresh rate by generating interpolation frame data based on the plurality of pieces of event data and the target event data.

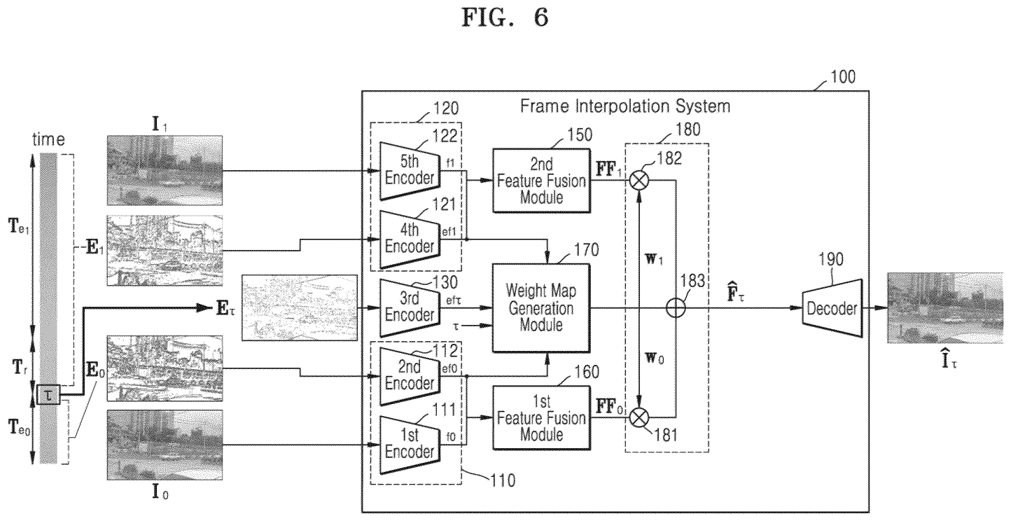

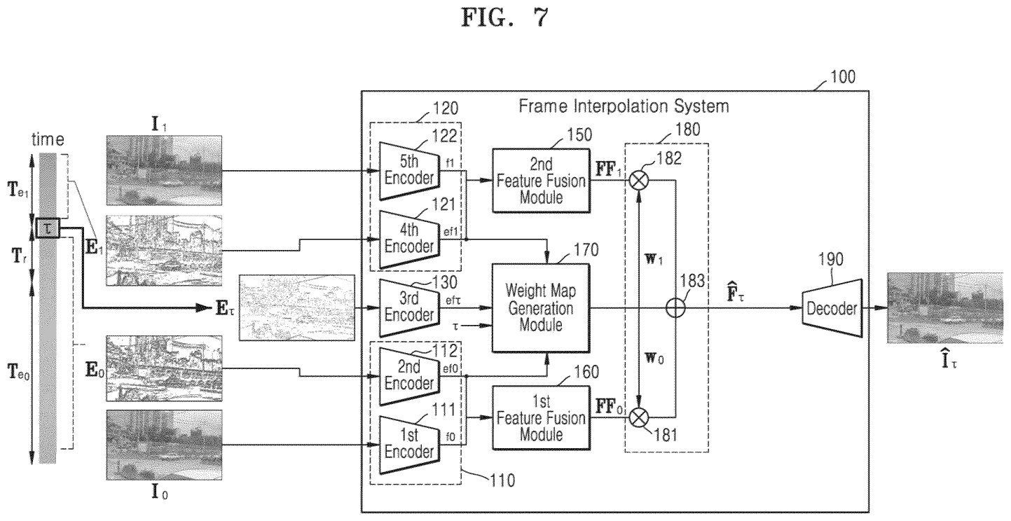

Although the target time point t is in the readout section Tᵣ in FIG. 3, the target time point τ may be in the first exposure section Tₑ₀ when referring to FIG. 6 and the target time point τ may be in the second exposure section Tₑ₁ when referring to FIG. 7, which will be described below. According to one or more embodiments, the target time point τ may be in the first exposure section Tₑ₀, the readout section Tᵣ, and the second exposure section Tₑ₁. Accordingly, the frame interpolation system 100 may generate interpolation frame data Î_{τ} and deblurred output frame data. In other words, the frame interpolation system 100 may generate high-quality and high-resolution images with blur removed during image processing.

FIG. 4 is a block diagram of the weight map generation module 170 according to one or more embodiments.

Referring to FIG. 4, the weight map generation module 170 may include first to sixth blocks B1 to B6, first and second softmax blocks SM1 and SM2, a reshape block RS1, and a convolution layer c1. The weight map generation module 170 may generate the first weight map wr by using the first to sixth blocks B1 to B6, the first and second softmax blocks SM1 and SM2, the reshape block RS1, and the convolution layer c1.

The first block B1 may receive the first event feature data ef0 generated by the second encoder 112. The first block B1 may generate first query data QE0 by linearly transforming the first event feature data ef0. Here, the linear transformation may include a matrix multiplication operation of the first event feature data ef0 and a matrix composed of certain parameters, or an inner product with a vector composed of certain parameters. The parameters of the matrix or vector may be learned together when training the NN 200. The second block B2 may receive the second event feature data ef1 generated by the fourth encoder 121. The second block B2 may generate second query data QE1 by linearly transforming the second event feature data ef1. The linear transformation may include a matrix multiplication operation of the second event feature data ef1 and a matrix composed of certain parameters, or an inner product with a vector composed of certain parameters. The parameters of the matrix or vector may be learned together when training the NN 200. The third block B3 and the sixth block B6 may receive target event feature data efτ generated by the third encoder 130. The third block B3 and the sixth block B6 may generate target key data KEt by linearly transforming the target event feature data eft. The linear transformation may include a matrix multiplication operation of the target event feature data efτ and a matrix composed of certain parameters, or an inner product with a vector composed of certain parameters. The parameters of the matrix or vector may be learned together when training the NN 200. Additionally, the parameters of the matrix or vector used in the linear transformation of the third block B3 and the sixth block B6 may be the same. That is, the target key data KEt generated by the third block B3 and the sixth block B6 may be the same. The fourth block B4 and the fifth block B5 may generate target value data VEt by linearly transforming the target event feature data eft. The linear transformation may include a matrix multiplication operation of the target event feature data efτ and a matrix composed of certain parameters, or an inner product with a vector composed of certain parameters. The parameters of the matrix or vector may be learned together when training the NN 200. Additionally, the parameters of the matrix or vector used in the linear transformation of the fourth block B4 and the fifth block B5 may be the same. That is, the target value data VEt generated by the fourth block B4 and the sixth block B6 may be the same.

The first to sixth blocks B1 to B6 may be referred to as first to sixth linear transformation blocks.

A first operator 171 may receive the first query data QE0 and the target key data KEt to perform a matrix multiplication operation. For example, the first operator 171 may operate the first query data QE0 generated by the first block B1 and the target key data KEt generated by the third block B3. The first operator 171 may generate first operation data r1 as a result of the matrix multiplication operation. The second operator 172 may receive the second query data QE1 and the target key data KEt to perform a matrix multiplication operation. For example, the second operator 172 may operate the second query data QE1 generated by the second block B2 and the target key data KEt generated by the sixth block B6. The second operator 172 may generate second operation data r2 as a result of the matrix multiplication operation.

The first softmax block SM1 may generate a first result s1 by applying the softmax function to the first operation data r1. For example, the first softmax block SM1 may receive first operation data r1 generated by the first operator 171 and generate the first result s1. The second softmax block SM2 may generate a second result s2 by applying the softmax function to the second operation data r2. For example, the second softmax block SM2 may receive the second operation data r2 generated by the second operator 172 to generate the second result s2.

A third operator 173 may receive the first result s1 and the target value data VEt and perform a matrix multiplication operation. For example, the third operator 173 may calculate the first result s1 generated by the first softmax block SM1 and the target value data VEt generated by the fourth block B4. The third operator 173 may generate third operation data At,0 as a result of the matrix multiplication operation. A fourth operator 174 may receive the second result s2 and the target value data VEt and perform a matrix multiplication operation. For example, the fourth operator 174 may calculate the second result s2 generated by the second softmax block SM2 and the target value data VEt generated by the fifth block B5. The fourth operator 174 may generate fourth operation data At,1 as a result of the matrix multiplication operation.

The reshape block RS1 may receive the third operation data At,0 and the fourth operation data At,1, reshape the same, and generate attention data Aτ,0 and Aτ,1. The reshape block RS1 may generate the attention data Aτ,0 and Aτ,1 by calculating the third operation data At,0 and the fourth operation data At,1. For example, when the third operation data At,0 and the fourth operation data At,1 are two-dimensional data, the reshape block RS1 may convert the same into three-dimensional data with the added channel dimension and then create attention data Aτ,0 and Aτ,1 bundled into one piece of data.

The fifth operator 175 may receive the attention data Aτ,0 and Aτ,1 and the target time point τ and perform channel-wise positional encoding. The channel-wise positional encoding may refer to performing an addition operation for each position of each channel. The fifth operator 175 may receive attention data Aτ,0 and Aτ,1 from the reshape block RS1, receive the target time point τ from the CPU 20 in FIG. 1, and perform channel-wise positional encoding to generate first result data cc1.

The convolution layer c1 may receive the first result data cc1 and generate the first weight map w_{τ}. The second weight map 1−w_{τ} may include a value obtained by subtracting the first weight map w_{τ} from 1.

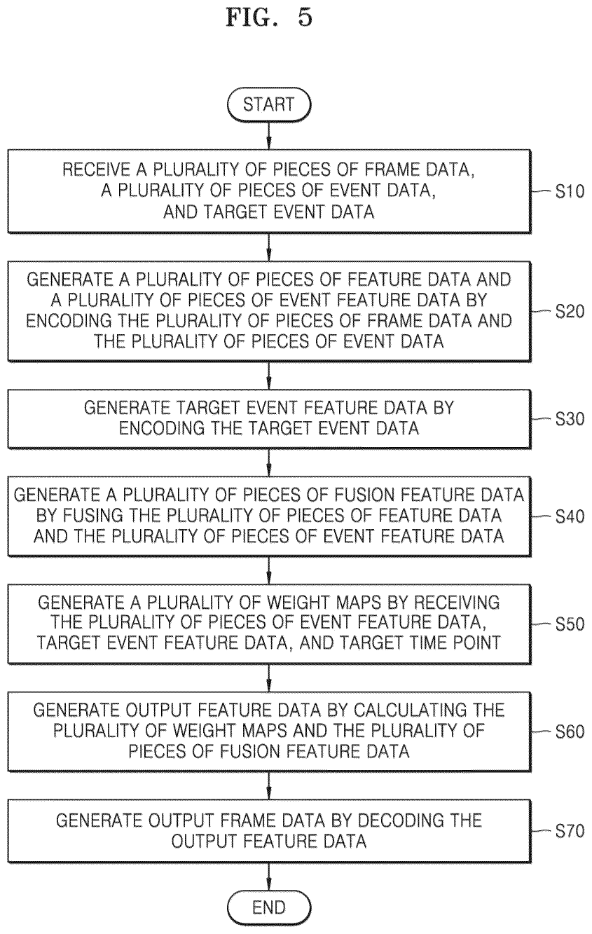

FIG. 5 is a flowchart of an operating method of a frame interpolation system according to one or more embodiments.

Referring to FIG. 5, in operation S10, each of the first encoder group 110, the second encoder group 120, and the third encoder 130 may receive a plurality of pieces of frame data, a plurality of pieces of event data, and target event data.

For example, referring to FIG. 3, the first encoder group 111 may receive the first frame data I₀ and the first event data E₀, the second encoder group 120 may receive the second frame data I₁ and the second event data E₁, and the third encoder 130 may receive the target event data E_{τ}.

In operation S20, each of the first encoder group 110 and the second encoder group 120 may generate a plurality of pieces of feature data and a plurality of pieces of event feature data by encoding the plurality of pieces of frame data and the plurality of pieces of event data.

For example, referring to FIG. 3, the first encoder 111 may generate the first feature data f0 by encoding the first frame data E₀ and the second encoder 112 may generate the first event feature data ef0 by encoding the first event data E₀. The fourth encoder 121 may generate the second event feature data ef1 by encoding the second event data E₁ and the fifth encoder 122 may generate the second feature data f1 by encoding the second frame data I₁.

In operation S30, the third encoder 130 may generate the target event feature data efτ by encoding the target event data E_{τ}.

In operation S40, each of the first feature fusion module 160 and the second feature fusion module 150 may generate a plurality of pieces of fusion feature data by fusing the plurality of pieces of feature data and the plurality of pieces of event feature data.

For example, referring to FIG. 3, the first feature fusion module 160 may generate first fusion feature data FF0 based on the first feature data f0 and the first event feature data ef0. The second feature fusion module 150 may generate second fusion feature data FF1 based on the second feature data f1 and the second event feature data ef1.

In operation S50, the weight map generation module 170 may generate a plurality of weight maps by receiving the plurality of pieces of event feature data ef0 and ef1, the target event feature data eft, and the target time point τ.

For example, referring to FIG. 3, the weight map generation module 170 may generate a first weight map t and a second weight map 1−w_{τ} for the target time point τ by receiving the first event feature data ef0, the second event feature data ef1, the target event feature data efτ, and the target time point τ.

In operation S60, the blending module 180 may generate output feature data \hat{F}_{τ} for the target time point τ by calculating the plurality of weight maps and the plurality of pieces of fusion feature data.

For example, referring to FIG. 3, the first multiplier 181 may perform an element-wise multiplication operation of the first fusion feature data FF0 and the first weight map w_{τ} and the second multiplier 182 may perform an element-wise multiplication operation of the second fusion feature data FF1 and the second weight map 1−w_{τ}. The adder 183 may generate output feature data \hat{F}_{τ} by adding the output value of the first multiplier 181 and the output value of the second multiplier 182.

In operation S70, the decoder 190 may generate output frame data Î_{τ} for the target time point τ by decoding the output feature data \hat{F}_{τ}.

For example, referring to FIG. 3, when the target time point τ is in the readout section Tᵣ between the first exposure section Tₑ₀ and the second exposure section Tₑ₁, the output frame data Î_{τ} may include intermediate frame data or interpolation frame data between the first frame data I₀ and the second frame data I₁.

In addition, referring to FIG. 6 to be described below, when the target time point τ is in the first exposure section Tₑ₀, the output frame data Î_{τ} may include frame data obtained by deblurring the first frame data I₀.

Referring to FIG. 7 to be described below, when the target time point τ is in the second exposure section Tₑ₁, the output frame data Î_{τ} may include frame data obtained by deblurring the second frame data I₁.

According to one or more embodiments, in the operating method of the frame interpolation system, the first frame data I₀, the first event data E₀, the second frame data I₁, the second event data E₁, and the target event data E_{τ} may be input based on an NN to generate accurate interpolation frame data Î_{τ}. Accordingly, an image with high quality and high refresh rate may be generated during the image processing operation.

FIG. 6 is a block diagram of a frame interpolation system according to one or more embodiments. Overlapping descriptions with reference to FIG. 3 may be omitted.

Referring to FIG. 6, the target time point τ may be in the first exposure section Tₑ₀ rather than the readout section Tᵣ. However, referring to FIG. 3, the target time point τ may be in the readout section Tᵣ between the first exposure section Tₑ₀ and the second exposure section Tₑ₁.

Referring back to FIG. 6, the first frame data I₀ may be generated by accumulating the signals from the image sensor during the first exposure section Tₑ₀, the first event data E₀ may be generated by accumulating signals from the event sensor during the same first exposure section Tₑ₀, the target event data E_{τ} may be generated at the target time point τ, and the second frame data I₁ and the second event data E₁ may be generated from the target time point τ to the second exposure section Tₑ₁.

The frame interpolation system 100 may receive the first frame data I₀, the first event data E₀, the second frame data I₁, the second event data E₁, and the target event data E_{τ}, wherein the frame interpolation system 100 may generate the output frame data Î_{τ} based thereon. The generated output frame data Î_{τ} may include frame data obtained by deblurring the first frame data I₀.

Thus, since the target time point τ is in the first exposure section Tₑ₀, the frame interpolation system 100 according to one or more embodiments may generate the output frame data obtained by deblurring the first frame data, rather than generating the interpolation frame data Î_{τ}. Accordingly, high-quality and high-resolution images with blur removed during the image processing operation may be generated. In other words, based on it being determined that the target time point is closer to a first time point of the first frame, an interpolated frame featuring the target event using deblurred data from the first frame is generated.

In addition, the frame interpolation system 100 according to one or more embodiments may generate deblurred output frame data based on the plurality of pieces of frame data, the plurality of pieces of event data, and the target event data by using the NN, thereby outputting high-resolution and high-quality images.

FIG. 7 is a block diagram of a frame interpolation system according to one or more embodiments. Overlapping descriptions with reference to FIG. 3 may be omitted.

Referring to FIG. 7, the target time point τ may be in the second exposure section Tₑ₁ rather than the readout section Tᵣ. However, referring to FIG. 3, the target time point τ may be in the readout section Tᵣ between the first exposure section Tₑ₀ and the second exposure section Tₑ₁.

Referring back to FIG. 7, the first frame data I₀ and first event data E₀ may be generated from the first exposure section Tₑ₀ to the target time point τ, the target event data E_{τ} may be generated at the target time point τ, the second frame data I₁ may be generated by accumulating the signals from the image sensor during the second exposure section Tₑ₁, and the second event data E₁ may be generated by accumulating the signals from the event sensor during the same second exposure section Tₑ₁.

The frame interpolation system 100 may receive the first frame data I₀, the first event data E₀, the second frame data I₁, the second event data E₁, and the target event data E_{τ}, wherein the frame interpolation system 100 may generate the output frame data Î_{τ} based thereon. The generated output frame data Î_{τ} may include frame data obtained by deblurring the second frame data I₁. In other words, based on it being determined that the target time point is closer to a second time point of the second frame, an interpolated frame featuring the target event using deblurred data from the second frame is generated.

Thus, since the target time point τ is in the second exposure section Tₑ₁, the frame interpolation system 100 according to one or more embodiments may generate output frame data obtained by deblurring the second frame data I₁, rather than generating the interpolation frame data Î_{τ}. Accordingly, high-quality and high-resolution images with blur removed during the image processing operation may be generated.

In addition, the frame interpolation system 100 according to one or more embodiments may generate deblurred output frame data based on the plurality of pieces of frame data, the plurality of pieces of event data, and the target event data by using the NN, thereby outputting high-resolution and high-quality images.

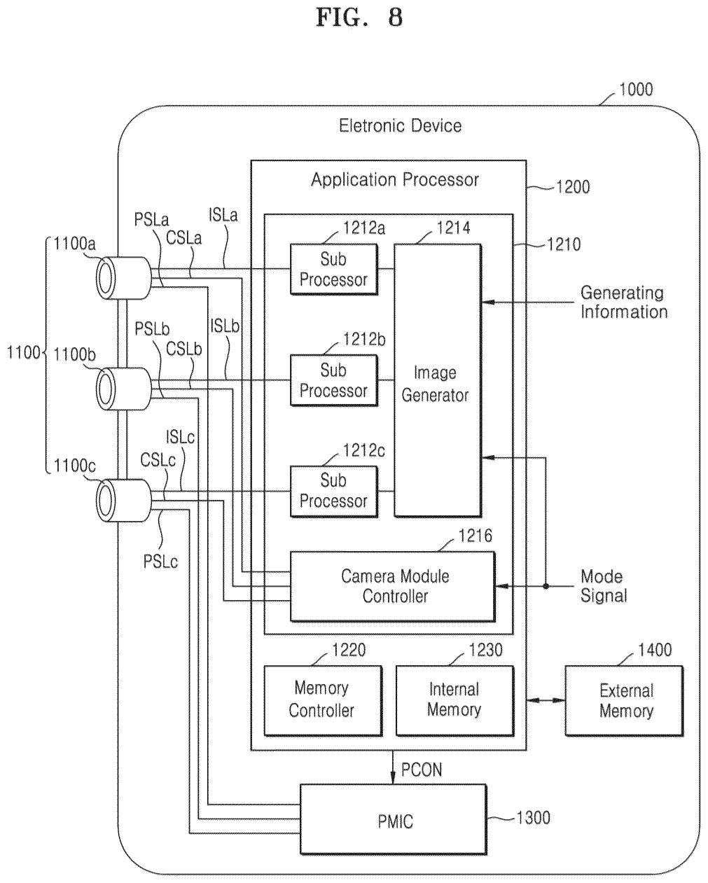

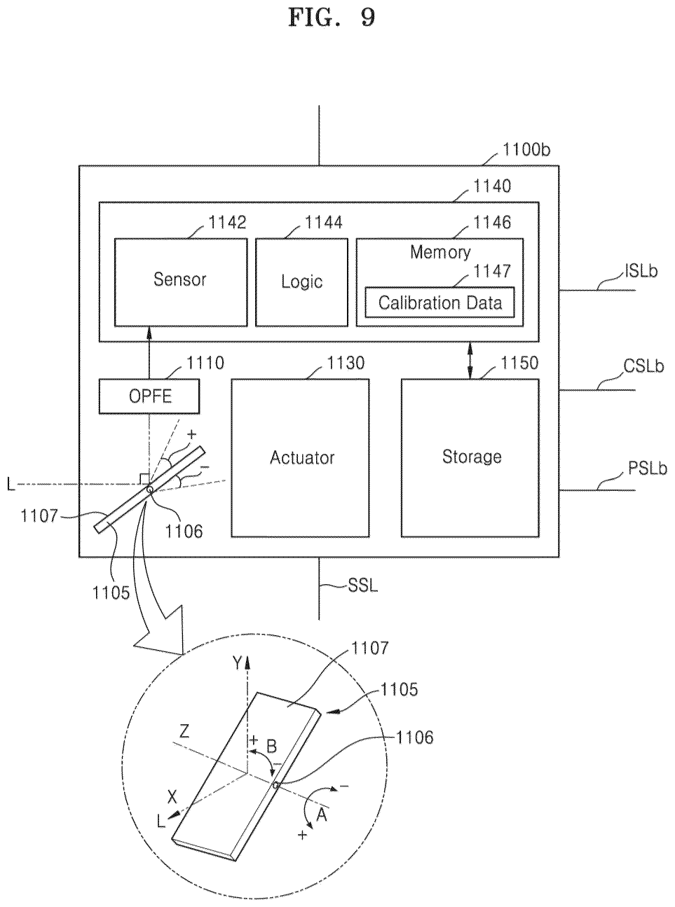

FIG. 8 is a block diagram of an electronic device 1000 including a multi-camera module according to one or more embodiments. FIG. 9 is a detailed block diagram of the camera module 1100b in FIG. 8.

FIG. 9 shows the detailed configuration of the camera module 1100b but the following description may be equally applied to other camera modules 1100a and 1100c depending on embodiments.

Referring to FIG. 8, the electronic device 1000 may include a camera module group 1100, an application processor 1200, a power module integrated circuit (PMIC) 1300, and external memory 1400. The camera module group 1100 may include a plurality of camera modules 1100a, 1100b, and 1100c. Although the drawing shows one or more embodiments in which three camera modules 1100a, 1100b, and 1100c are arranged, embodiments are not limited thereto. The camera modules 1100a, 1100b, and 1100c may correspond to the camera module 40 shown in FIG. 1.

Referring to FIGS. 8 and 9, the camera module 1100b may include a prism 1105, an optical path folding element (OPFE) 1110, an actuator 1130, an image sensing device 1140, and storage 1150.

The prism 1105 including a reflective surface 1107 of a light-reflecting material may change the path of light L incident from the outside. The OPFE 1110 may include, for example, an optical lens consisting of m groups, where m is a natural number. The actuator 1130 may move the OPFE 1110 or the optical lens (hereinafter referred to as an optical lens) to a specific position.

The image sensing device 1140 may include a sensor 1142, logic 1144, and memory 1146. The image sensor 1142 may sense the image of the sensing object by using the light L provided by the optical lens. The image sensor 1142 may include the camera module 40 described in FIG. 1.

The control logic 1144 may control the overall operation of the camera module 1100b. For example, the control logic 1144 may control the operation of the camera module 1100b according to a control signal provided through a control signal line CSLb.

In one or more embodiments, one camera module (e.g., 1100b) among the plurality of camera modules 1100a, 1100b, and 1100c may include a camera module in the form of a folded lens including the prism 1105 and the OPFE 1110 described above and the other camera modules (e.g., 1100a and 1100b) may include vertical camera modules that do not include the prism 1105 and the OPFE 1110 but embodiments are not limited thereto.

In one or more embodiments, one camera module (e.g., 1100c) among the plurality of camera modules 1100a, 1100b, and 1100c may include a vertical depth camera that extracts depth information using infrared ray (IR). In this case, the application processor 1200 may generate three-dimensional (3D) depth images by merging the image data values provided from the depth camera with the image data values provided from another camera module (e.g., 1100a or 1100b).

In one or more embodiments, one camera module (e.g., 1100c) among the plurality of camera modules 1100a, 1100b, and 1100c may include, for example, an event camera that generates event signals. In this case, the application processor 1200 may generate an event image by accumulating event data provided from the event camera over a random period of time.

In one or more embodiments, among the plurality of camera modules 1100a, 1100b, and 1100c, at least two camera modules (e.g., 1100a, 1100b) may have different fields of view. In this case, for example, the optical lenses of at least two camera modules (e.g., 1100a, 1100b) among the plurality of camera modules 1100a, 1100b, and 1100c may be different from each other but are not limited thereto.

In addition, in one or more embodiments, the fields of view of the camera modules 1100a, 1100b, and 1100c may be different from each other. In this case, optical lenses respectively included in the plurality of camera modules 1100a, 1100b, and 1100c may also be different from each other but are not limited thereto.

In one or more embodiments, the plurality of camera modules 1100a, 1100b, and 1100c may be physically separated from each other. In other words, the sensing area of one image sensor 1142 may not be divided and used by the plurality of camera modules 1100a, 1100b, and 1100c. Rather, an independent image sensor 1142 may be positioned inside each of the plurality of camera modules 1100a, 1100b, and 1100c.

Referring again to FIG. 8, the application processor 1200 may include an image processing device 1210, a memory controller 1220, and internal memory 1230. The application processor 1200 may be implemented separately from the plurality of camera modules 1100a, 1100b, and 1100c. For example, the application processor 1200 and the plurality of camera modules 1100a, 1100b, and 1100c may be implemented separately as separate semiconductor chips.

The image processing device 1210 may include a plurality of sub processors 1212a, 1212b, and 1212c, an image generator 1214, and a camera module controller 1216.

The image processing device 1210 may include the plurality of sub processors 1212a, 1212b, and 1212c corresponding to the number of camera modules 1100a, 1100b, and 1100c.

The image processing device 1210 according to one or more embodiments may include a frame interpolation system (100 in FIG. 1). The frame interpolation system may generate accurate interpolation frame data based on the first frame data, the first event data, the second frame data, the second event data, and the target event data. Accordingly, when the image processing device 1210 performs the image processing operation, an image with a high refresh rate, high resolution, and high quality may be generated.

The image data values generated from the camera modules 1100a, 1100b, and 1100c may be provided to the corresponding sub-image processors 1212a, 1212b, and 1212c through image signal lines ISLa, ISLb, and ISLc, respectively. For example, the image data value generated from the camera module 1100a may be provided to the sub-image processor 1212a through the image signal line ISLa, the image data value generated from the camera module 1100b may be provided to the sub-image processor 1212b through the image signal line ISLb, and the image data value generated from the camera module 1100c may be provided to the sub-image processor 1212c through the image signal line ISLc. Transmission of these image data values may be performed, for example, using a camera serial interface (CSI) based on a mobile industry processor interface (MIPI) but embodiments are not limited thereto.

The image data value provided to each sub-image processor 1212a, 1212b, and 1212c may be provided to the image generator 1214. The image generator 1214 may generate an output image by using image data provided from each sub-image processor 1212a, 1212b, and 1212c according to image generating information or mode signals.

Specifically, the image generator 1214 may generate the output image by merging at least some of the image data values generated from the camera modules 1100a, 1100b, and 1100c with different fields of view according to the image generation information or mode signals. In addition, the image generator 1214 may select one of image data values generated from the camera modules 1100a, 1100b, and 1100c having different fields of view according to the image generation information or mode signals to generate the output image.

The camera module controller 1216 may provide control signals to each camera module 1100a, 1100b, and 1100c. The control signals generated from the camera module controller 1216 may be provided to the corresponding camera modules 1100a, 1100b, and 1100c through separate control signal lines CSLa, CSLb, and CSLc.

The application processor 1200 may store the received image data values, i.e., encoded data, in the internal memory 1230 or external memory 1400 and then read and decode the encoded data from the internal memory 1230 or the external memory 1400 to display an image generated based on the decoded image data values. For example, among the plurality of sub-processors 1212a, 1212b, and 1212c of the image processing device 1210, a corresponding sub-processor may perform decoding and may also perform image processing on the decoded image data values.

The PMIC 1300 may supply power, for example, power voltage, to each of the plurality of camera modules 1100a, 1100b, and 1100c. For example, under the control by the application processor 1200, the PMIC 1300 may supply first power to the camera module 1100a through a power signal line PSLa, supply second power to the camera module 1100b through a power signal line PSLb, and supply third power to the camera module 1100c through a power signal line PSLc.

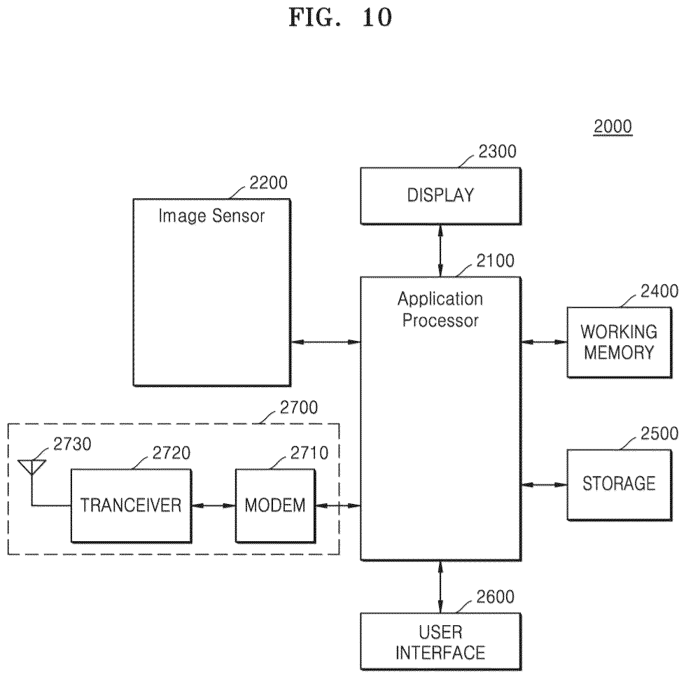

FIG. 10 is a block diagram of an electronic device 2000 according to one or more embodiments. For example, the electronic device 2000 may include a portable terminal.

Referring to FIG. 10, the electronic device 2000 according to one or more embodiments may include an application processor 2100, an image sensor 2200, a display 2300, working memory 2400, storage 2500, a user interface 2600, and a wireless transmitter and receiver 2700. The description of the frame interpolation system and the operating method of the frame interpolation system according to some embodiments described with reference to FIGS. 1 to 9 may be applied to the image sensor 2200 and the application processor 2100.

The application processor 2100 may be provided as a SoC that runs an application program, an operating system, and the like by controlling the overall operation of the electronic device 2000. The application processor 2100 may receive output data from the image sensor 2200.

The application processor 2100 may include a frame interpolation system (100 in FIG. 1). The frame interpolation system may generate accurate interpolation frame data based on the first frame data, the first event data, the second frame data, the second event data, and the target event data. Accordingly, when the image processing device 1210 performs the image processing operation, an image with a high refresh rate, high resolution, and high quality may be generated.

The image sensor 2200 may generate image data, e.g., image data based on the received optical signal and may provide the image data to the application processor 2100. The image sensor 2200 may correspond to the camera module 40 shown in FIG. 1.

The working memory 2400 may be implemented as volatile memory, such as DRAM and SRAM, or non-volatile resistive memory, such as FeRAM, RRAM, and PRAM. The working memory 2400 may store programs and/or data processed or executed by the application processor 2100.

The storage 2500 may be implemented as a non-volatile memory device, such as NAND flash or resistive memory. For example, the storage 2500 may be provided as a memory card (e.g., MMC, eMMC, SD, micro SD). The storage 2500 may store data and/or programs for execution algorithms that control the image processing operation of the image sensor 2200, wherein the data and/or programs may be loaded into the working memory 2400 when the image processing operation is performed. In one or more embodiments, the storage 2500 may store the output image data generated by the image sensor 2200, for example, corrected image data or post-processed image data.

The user interface 2600 may be implemented as various devices that can receive user input, such as a keyboard, a curtain key panel, a touch panel, a fingerprint sensor, and a microphone. The user interface 2600 may receive user input and provide a signal corresponding to the received user input to the application processor 2100.

The wireless transmitter and receiver 2700 may include a transceiver 2720, a modem 2710, and an antenna 2730.

While the inventive concept has been particularly shown and described with reference to embodiments thereof, it will be understood that various changes in form and details may be made therein without departing from the spirit and scope of the following claims.

1. A frame interpolation system comprising:
a first plurality of encoders configured to receive first frame data and first event data and generate first feature data and first event feature data;
a second plurality of encoders configured to receive second frame data and second event data and generate second feature data and second event feature data;
a third encoder configured to receive target event data at a target time point and generate target event feature data;
a feature fusion module configured to generate first fusion feature data based on the first feature data and the first event feature data and generate second fusion feature data based on the second feature data and the second event feature data;
a weight map generation module configured to generate a first weight map and a second weight map in response to receiving the first event feature data, the second event feature data, the target event feature data, and the target time point;
a blending module configured to generate output feature data by performing an operation on the first fusion feature data, the second fusion feature data, the first weight map, and the second weight map; and
a decoder configured to generate output frame data by decoding the output feature data.

2. The frame interpolation system of claim 1, wherein the target time point is between a first time when the first frame data is generated and a second time when the second frame data is generated, and the target event data is between the first frame data and the second frame data.

3. The frame interpolation system of claim 1,
wherein the first plurality of encoders comprises a first encoder configured to encode the first frame data and generate the first feature data and a second encoder configured to encode the first event data and generate the first event feature data,
wherein the second plurality of encoders comprises a fourth encoder configured to encode the second event data and generate the second event feature data and a fifth encoder configured to encode the second frame data and generate the second feature data, and
wherein the first encoder and the fifth encoder are further configured to share parameters for encoding operation performance and the second encoder and the fourth encoder are further configured to share parameters for encoding operation performance.

4. The frame interpolation system of claim 1, wherein the feature fusion module comprises:
a first feature fusion module configured to generate the first fusion feature data by fusing the first feature data and the first event feature data; and
a second feature fusion module configured to generate the second fusion feature data by fusing the second feature data and the second event feature data.

5. The frame interpolation system of claim 1, wherein the weight map generation module comprises a plurality of blocks, wherein the plurality of blocks are configured to perform a matrix multiplication operation, a softmax operation, a channel-wise addition operation, and a convolution operation on the first event feature data, the second event feature data, the target event feature data, and the target time point and generate the first weight map.

6. The frame interpolation system of claim 5, wherein the second weight map is equal to 1 minus the first weight map.

7. The frame interpolation system of claim 1, wherein the output feature data is a sum of a product of the first fusion feature data and the first weight map and a product of the second fusion feature data and the second weight map.

8. The frame interpolation system of claim 2, wherein the output frame data comprises intermediate frame data between the first frame data and the second frame data.

9. The frame interpolation system of claim 1, wherein, based on the target time point being at a first time when the first frame data is generated, the output frame data comprises deblurred first frame data.

10. The frame interpolation system of claim 1, wherein, based on the target time point being at a second time when the second frame data is generated, the output frame data comprises deblurred second frame data.

11. An operating method of a frame interpolation system, the method comprising:
receiving a plurality of pieces of frame data, a plurality of pieces of event data, and target event data;
generating a plurality of pieces of feature data and a plurality of pieces of event feature data by encoding the plurality of pieces of frame data and the plurality of pieces of event data;
generating target event feature data by encoding the target event data;
generating a plurality of pieces of fusion feature data by fusing the plurality of pieces of feature data and the plurality of pieces of event feature data;
generating a plurality of weight maps in response to receiving the plurality of pieces of event feature data, the target event feature data, and a target time point;
generating output feature data by performing an operation on the plurality of weight maps and the plurality of pieces of fusion feature data; and
generating output frame data by decoding the output feature data.

12. The method of claim 11,
wherein the plurality of pieces of frame data comprise first frame data and second frame data,
wherein the plurality of pieces of event data comprise first event data and second event data,
wherein the plurality of pieces of feature data comprise first feature data and second feature data,
wherein the plurality of pieces of event feature data comprise first event feature data and second event feature data,
wherein the plurality of pieces of fusion feature data comprise first fusion feature data and second fusion feature data, and
wherein the plurality of weight maps comprise a first weight map and a second weight map.

13. The method of claim 12, wherein the generating of the plurality of weight maps comprises performing a matrix multiplication operation, a softmax operation, a channel-wise addition operation, and a convolution operation on the first event feature data, the second event feature data, the target event feature data, and the target time point.

14. The method of claim 12, wherein, in the generating of the output feature data, the output feature data is a sum of a product of the first fusion feature data and the first weight map and a product of the second fusion feature data and the second weight map.

15. The method of claim 12, wherein, based on the target time point being between sections in which the first frame data and the second frame data are generated, the output frame data comprises intermediate frame data between the first frame data and the second frame data.

16. The method of claim 12,
wherein, based on the target time point being in a section in which the first frame data is generated, the output frame data comprises frame data obtained by deblurring the first frame data, and
wherein, based on the target time point being in a section in which the second frame data is generated, the output frame data comprises frame data obtained by deblurring the second frame data.

17. An image processing device comprising:
a frame interpolation system configured to perform an image processing operation on input images and produce output images, wherein the frame interpolation system comprises:
a first encoder configured to receive and encode first frame data to generate first feature data;
a second encoder configured to receive and encode first event data to generate first event feature data;
a third encoder configured to receive and encode target event data to generate target event feature data;
a fourth encoder configured to receive and encode second frame data to generate second event feature data;
a fifth encoder configured to receive and encode second event data to generate second feature data;
a first feature fusion module configured to generate first fusion feature data in response to receiving the first feature data and the first event feature data;
a second feature fusion module configured to generate second fusion feature data in response to receiving the second feature data and the second event feature data;
a weight map generation module configured to generate a first weight map and a second weight map in response to receiving the first event feature data, the second event feature data, the target event feature data, and a target time point;
a blending module configured to generate output feature data by performing an operation on the first fusion feature data, the second fusion feature data, the first weight map, and the second weight map; and
a decoder configured to generate output frame data by decoding the output feature data,
wherein the frame interpolation system comprises a neural network.

18. The image processing device of claim 17, wherein the output feature data is a sum of a product of the first fusion feature data and the first weight map and a product of the second fusion feature data and the second weight map.

19. The image processing device of claim 17, wherein, based on the target time point being between sections in which the first frame data and the second frame data are generated, the target event data is between the first frame data and the second frame data, and the output frame data comprises intermediate frame data between the first frame data and the second frame data.

20. The image processing device of claim 17, wherein, based on the target time point being in a section in which the first frame data is generated or in a section in which the second frame data is generated, the output frame data comprises frame data obtained by deblurring at least one of the first frame data or the second frame data.

21. (canceled)
